(19) United States
(12) Patent Application Publication
(10) Pub. No.: US 2006/0182952 A1
(43) Pub. Date: Aug. 17, 2006

(54) Encapsulated thermally conductive electrically insulating assembly and method to prepare same

(76) Inventors: Roger Javier Justo, Tucson, AZ (US); Wayne Alan McKinley, Tucson, AZ (US); Hussain Shaukatullah, Tucson, AZ (US); George G. Zamora, Vail, AZ (US)

Correspondence Address: DALE F. REGELMAN, 4231 S. FREMONT AVENUE, TUCSON, AZ, 85714, US

(21) Appl. No.: 11/326,648

(22) Filed: Jan. 6, 2006

Related U.S. Application Data
(63) Continuation-in-part of application No. 10/041,111, filed on Jan. 8, 2002, now abandoned.

(51) Int. Cl. B32B 7/12

(52) U.S. Cl. 428/343

(57) ABSTRACT

An electrically-insulating assembly is disclosed. The electrically-insulating assembly comprises a member having a thermal conductivity greater than 1 W/mK, and a film encapsulating that member, wherein the film has a thermal conductivity of less than 0.5 W/mK, and wherein the encapsulating film prevents release from the electrically-insulating assembly of any silicone oils emitted by the member.

### CROSS REFERENCE TO RELATED APPLICATIONS

This Application claims priority from a U.S. Utility application having Ser. No. 10/041,111 filed Jan. 8, 2002.

### FIELD OF THE INVENTION

Applicants' invention relates to an encapsulated thermally conductive electrically insulating, non-contaminating gap filler assembly. Applicants' invention further relates to a method to form an encapsulated thermally conductive electrically insulating, non-contaminating gap filler assembly.

### BACKGROUND OF THE INVENTION

Circuit density and power dissipation of integrated circuits comprising a plurality of components packaged in a single device are increasing. In addition, these heat-generating devices are housed in smaller and smaller packages resulting in increased power dissipation from a relatively small volume. Frequently due to package size constraints, there is insufficient space to install cooling fans in electronic devices comprising such integrated circuits.

Magnetic tape drive units and optical disk/floppy disk/hard disk drive units include heat-generating electronic components in combination with a number of high-precision moving parts, such as read/write heads, that are positioned in close proximity to moving data storage media. These moving parts are very susceptible to contamination. Therefore, components and materials used in such drive units must be free from contaminants, including solids, semi-solids, and liquids. In addition, such components and/or materials cannot release liquids and/or vapors that could contaminate moving parts, magnetic or optical media, and read/write heads, or that could form a encapsulating film on moving parts, and thereby, facilitate the accumulation of dust and debris.

What is needed is an electrically-insulating, non-contaminating, gap-filing, assembly to conduct heat from heat-generating components to a metal chassis.

### SUMMARY OF THE INVENTION

Applicants' invention comprises an encapsulated thermally conductive electrically-insulating assembly, comprising a member having a thermal conductivity greater than 1 W/mK, and a film encapsulating that member, wherein the film has a thermal conductivity of less than 0.5 W/mK, and wherein the encapsulating film prevents release from the electrically-insulating assembly of any silicone oils emitted by the member.

### BRIEF DESCRIPTION OF THE DRAWINGS

The invention will be better understood from a reading of the following detailed description taken in conjunction with the drawings in which like reference designators are used to designate like elements, and in which:

FIG. 1A is a cross sectional view of a first embodiment of Applicants' electrically-insulating assembly;

FIG. 1B is a cross sectional view of one embodiment of an elastomeric thermally conductive elastomeric member used to form Applicants' flexible thermally conductive assembly;

FIG. 2A is a cross sectional view of a laminate film comprising two film layers;

FIG. 2B is a cross sectional view of a second embodiment of Applicants' electrically-insulating assembly comprising the film laminate of FIG. 2A;

FIG. 3A is a cross sectional view of a laminate film comprising three film layers;

FIG. 3B is a cross sectional view of a third embodiment of Applicants' electrically-insulating assembly comprising the film laminate of FIG. 3A; and

FIG. 4 is a flowchart summarizing Applicants' method to form their flexible thermally conductive assembly.

### DETAILED DESCRIPTION OF THE PREFERRED EMBODIMENTS

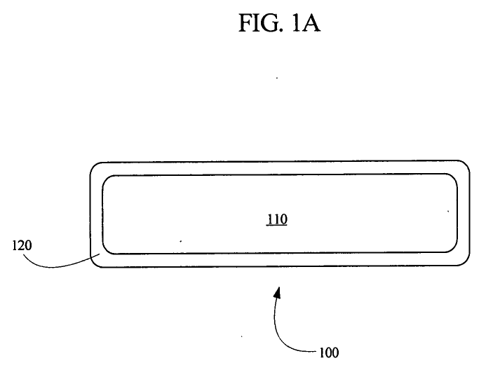

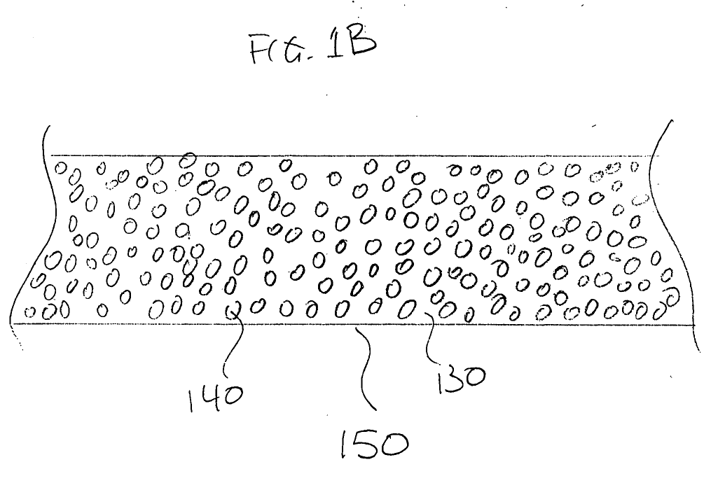

Referring to FIG. 1, flexible thermally conductive assembly 100 comprises member 110 and encapsulating film 120. Encapsulating film 120 comprises a contiguous film which completely encapsulates member 110.

Member 110 comprises a Shore A hardness, determined using Method ASTM 2240 promulgated by the American Society for Testing and Materials (“ASTM”), of between about 5 A and about 95 A. As those skilled in the art will appreciate, the hardness testing of plastics, including synthetic elastomers, is most commonly measured by the Shore (Durometer) test or Rockwell hardness test. Both methods measure the resistance of the plastic toward indentation. Shore Hardness, using either the Shore A or Shore D scale, is the preferred method for rubbers/elastomers and is also commonly used for “softer” plastics such as polyolefins, fluoropolymers, and vinyls. The Shore A scale is used for “softer” rubbers while the Shore D scale is used for “harder” ones.

The Shore hardness is measured with an apparatus known as a Durometer and consequently is also known as “Durometer hardness.” The hardness value is determined by the penetration of the Durometer indenter foot into the sample. The ASTM test number is ASTM D2240 while the analogous ISO test method is ISO 868.

Member 110 is thermally conductive. By “thermally conductive,” Applicants mean a material having a thermal conductivity λ of greater than 1 Watt per meter degree Kelvin (W/m K). As those skilled in the art will appreciate, the thermal conductivity, λ, is the quantity of heat transmitted, due to unit temperature gradient, in unit time under steady conditions in a direction normal to a surface of unit area, when the heat transfer is dependent only on the temperature gradient. In certain embodiments, member 110 has a thermal conductivity λ equal to or greater than 2 W/m K.

Referring now to FIG. 1B, thermally conductive member 110 comprises multi-phase structure 150 wherein continuous phase 130 comprises one or more polymeric material(s), and discontinuous phase 140 includes one or more additive(s). As those skilled in the art will appreciate, the sizes of the individual discontinuous components 140 shown in FIG. 1B are exaggerated with respect to the size of member 110 for illustrative purposes. In general, these discontinuous components 140 are not individually discernable without the use of magnification.

In certain embodiments, continuous phase 130 comprises a crosslinked polydialkylsiloxane. In certain embodiments, member 110 comprises a “gel” material 130 in combination with one or more thermally conductive solids 140. In these embodiments, the discontinuous phase comprises one or more solid materials, such as alumina or silica, colloidally suspended in the continuous phase gel.

In certain embodiments, continuous phase 130 comprises a cellular structure which includes open cells and/or closed cells and/or combinations thereof. As those skilled in the art will appreciate, the cellular embodiments of continuous phase 130 have lesser densities than do their non-cellular analogs.

In certain embodiments, discontinuous phase 140 includes one or more solids, one or more semi-solids, one or more liquids, and combinations thereof. By solids, Applicants mean materials having both a volume and a shape that are invariant at room temperature. By liquids, Applicants mean materials having a volume, but not a shape, that is invariant at room temperature. By semi-solids, Applicants mean components that include both solids and liquids.

In certain embodiments, discontinuous phase 140 includes alumina, silica, beryllium oxide, copper, aluminum, silver, gold, diamond, boron nitride, and combinations thereof. In certain embodiments, discontinuous phase 140 includes one or more linear polydialkylsiloxanes, such as polydimethylsiloxane, of varying molecular weights.

In certain embodiments, member 110 has a thickness of between about 0.5 mm and about 5 cm. In certain embodiments, member 110 has a thickness of between about 3 mm and about 5 mm. The length and width of member 110 can vary over large ranges. In certain embodiments, the length of member 110 is between about 0.5 cm and about 50 cm in length. In certain embodiments, the width of member 110 is between about 0.5 cm and about 50 cm in width. Other widths and lengths to meet specific applications are possible and acceptable.

In certain embodiments, member 110 comprises one or more products sold by The Bergquist Company (Gap Pad VO™ and Gap Pad VO Soft™), 5300 Edina Industrial Blvd., Minneapolis, Minn. 55439; Fujipoly (SARCON®), 365 Carnegie Avenue, Kenilworth, N.J. 07033; Parker Seals/CHOMERICS (Therma-A-Gap™), 77 Dragon Court, Woburn, Mass., 01888; and Kersamische Folien Gmbh (KERATHERM®), Stegenthumbach 4-6, D-92676 Eschenbach i.d. Opf., Germany.

Applicants have found, however, that these commercially-available materials suffer from a common problem, namely, release of contaminants in actual use. Such contaminants include, for example, one or more silicone oils. In order to minimize the unwanted release of such contaminants, Applicants' invention includes disposing member 110 within encapsulating film 120. Encapsulating film 120 prevents the release of materials emitted by member 110. Such emitted materials include gaseous materials, liquid materials, solid materials, semi-solid materials, and combinations thereof. In certain embodiments, such emitted materials comprise one or more silicone oils. Because siloxane polymers are permeable to silicone oils, encapsulating film 120 does not comprise a polydialkylsiloxane.

In certain embodiments, encapsulating film 120 is between about 0.01 mm and about 0.1 mm in thickness. In other embodiments, encapsulating film 120 has a thickness less than about 0.01 mm. In yet other embodiments, encapsulating film 120 has a thickness greater than about 0.1 mm.

Encapsulating film 120 is an electrically-insulating material. By electrically-insulating, Applicants mean a material that has a dielectric strength of at least 100 volts/mil at a one mil thickness. As those skilled in the art will appreciate, the dielectric strength of a material comprises the maximum electric field strength that it can withstand intrinsically without breaking down, i.e., without experiencing failure of its insulating properties. In certain embodiments, encapsulating film 120 has a dielectric strength of at least 15 kV/mm. In certain embodiments, encapsulating film 120 has a dielectric strength of at least 25 kV/mm.

Applicants' gap filling assembly can be disposed between one or more heat generating components and a metal chassis housing those one or more heat-generating components, i.e. Applicants' assembly fills space between a component and the chassis. In order to prevent the release of materials emitted by member 110 when inserted between one or more electrical components and a metal housing, encapsulating film 120 should not tear or break when subjected to a tensile stress. In certain embodiments, encapsulating film 120 has an elongation at break of greater than 100 percent using ASTM Method D882A.

In certain embodiments, encapsulating film 120 comprises a non-thermally conductive material. By “non-thermally conductive material,” Applicants mean a material having a thermal conductivity of less than 0.5 W/mK.

In certain embodiments, encapsulating film 120 comprises a polyethylene film. By polyethylene (“PE”) Applicants mean low density PE, linear low density PE, high density PE, ultra high molecular weight PE, and combinations thereof. For example, polyethylene film comprises a thermal conductivity of 0.42 Watts/mK, a dielectric strength of 28 kV/mm, and an elongation of 300 percent or greater.

In certain embodiments, encapsulating film 120 comprises a polyethylene terephthalate (“PET”) film. In certain embodiments, Applicants' PET film comprises a thermal conductivity of 0.2 W/mK, a dielectric strength of 17 kV/mm, and an elongation at break of 110 percent or greater.

In certain embodiments, encapsulating film 120 comprises a two layer laminate comprising a layer of PE film and a layer of PET film.

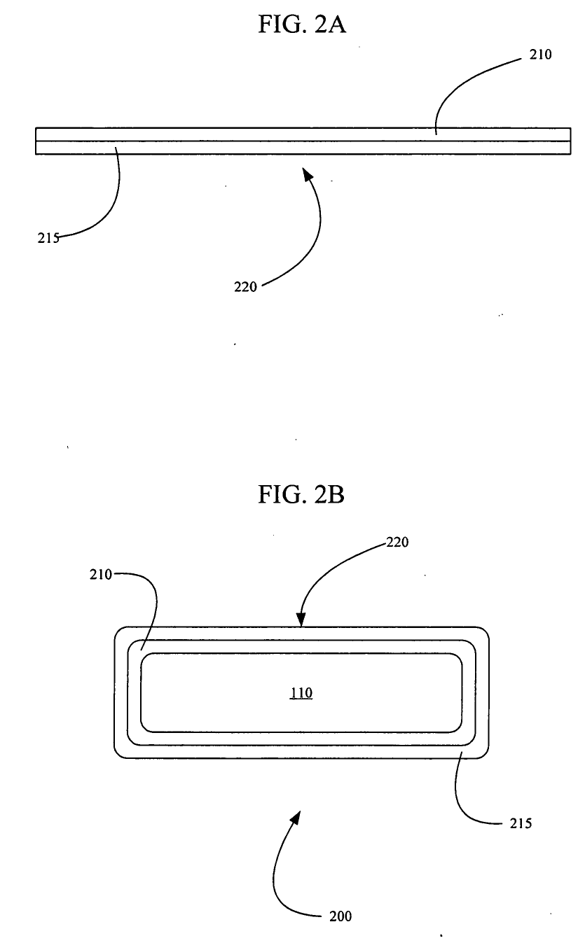

Referring now to FIG. 2A, film laminate 220 comprises a first film layer 210 and a second film layer 215. Referring now to FIG. 2B, Applicants' electrically-insulating assembly 200 comprises member 110 disposed within encapsulating film laminate 220.

In certain embodiments, first film layer 210 is selected from the group consisting of polyethylene and polyethylene terephthalate. By polyethylene (“PE”) Applicants mean low density PE, linear low density PE, high density PE, ultra high molecular weight PE, and combinations thereof. In certain embodiments, first film layer 210 has a thickness between about 0.01 mm and about 0.5 mm. In other embodiments, first film layer 210 has a thickness less than about 0.01 mm. In yet other embodiments, first film layer 210 has a thickness greater than about 0.5 mm.

In certain embodiments, second film layer 215 is selected from the group consisting of polyethylene and polyethylene terephthalate. In certain embodiments, second film layer 215 has a thickness between about 0.01 mm and about 0.5 mm. In other embodiments, second film layer 215 has a thickness less than about 0.01 mm. In yet other embodiments, second film layer 215 has a thickness greater than about 0.5 mm.

In one embodiment, assembly 200 comprises member 110 disposed within an encapsulant formed from a two layer laminate wherein that laminate comprises an inner layer formed from polyethylene film having a thickness of about 0.05 mm, and an outer layer formed from polyethylene terephthalate film having a thickness of about 0.05 mm.

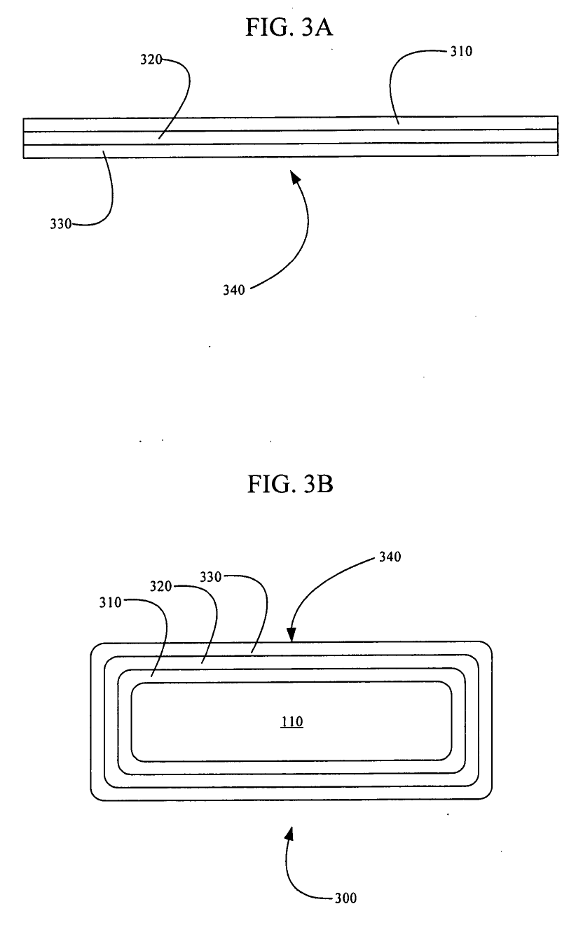

Referring to FIG. 3A, film laminate 340 comprises a first film layer 310, a second film layer 320, and a third film layer 330. Referring now to FIG. 3B, Applicants' electrically-insulating assembly 300 comprises member 110 disposed within encapsulating film laminate 340.

In certain embodiments, first film layer 310 comprises a metal layer. Metal layer 310 comprises one or more metals selected from the group consisting of copper, aluminum, steel, gold, silver, chromium, nickel, iron, titanium, magnesium, manganese, tin, and mixtures thereof. In certain embodiments, metal layer 310 comprises aluminum. In certain embodiments, metal layer 310 has a thickness between about 0.1 μm and about 50 μm.

In certain embodiments, second film layer 320 is selected from the group consisting of polyethylene and polyethylene terephthalate. By polyethylene (“PE”) Applicants mean low density PE, linear low density PE, high density PE, ultra high molecular weight PE, and combinations thereof. In certain embodiments, second film layer 320 has a thickness between about 0.01 mm and about 0.5 mm. In other embodiments, second film layer 320 has a thickness less than about 0.01 mm. In yet other embodiments, second film layer 320 has a thickness greater than about 0.5 mm.

In certain embodiments, third film layer 330 is selected from the group consisting of polyethylene and polyethylene terephthalate. In certain embodiments, third film layer 330 has a thickness between about 0.01 mm and about 0.5 mm. In other embodiments, third film layer 330 has a thickness less than about 0.01 mm. In yet other embodiments, third film layer 330 has a thickness greater than about 0.5 mm.

In one embodiment, assembly 300 comprises member 110 disposed within an encapsulant formed from a three layer laminate wherein that laminate comprises an inner metal film having a thickness of thickness between about 0.1 μm and about 50 μm, a middle layer formed from polyethylene film having a thickness of about 0.05 mm, and an outer layer formed from polyethylene terephthalate film having a thickness of about 0.05 mm.

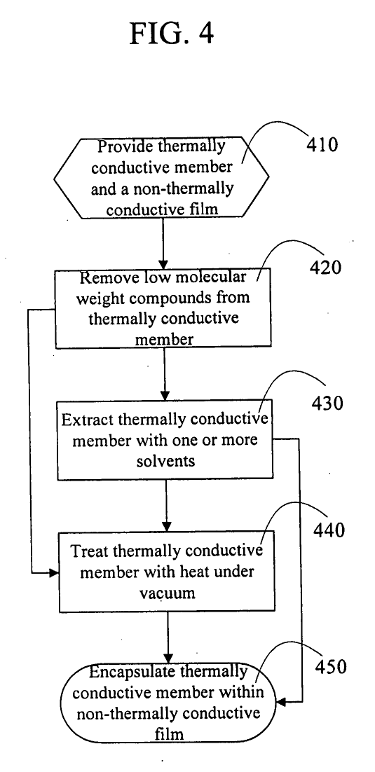

FIG. 4 summarizes the steps in Applicants' method to form assembly 100/200/300. In step 610, a thermally conductive member, such as member 110, is fashioned to appropriate dimensions, i.e. length, width, and thickness. In step 420 low molecular weight components are removed from that thermally conductive member. By low molecular weight compounds, Applicants mean compounds having a molecular weight less than about 1,000 daltons.

In certain embodiments of Applicants method, step 420 comprises step 430 wherein the appropriately dimensioned thermally conductive member is solvent extracted to remove low molecular weight components, i.e. silicone oils, monomers, oligomers, and the like. As those skilled in the art will appreciate, an appropriate apparatus, such as a Soxhlet apparatus, and an appropriate extraction solvent, are used.

In certain embodiments, step 420 comprises step 440 wherein the appropriately dimensioned thermally conductive member is heated at an elevated temperature at a reduced pressure to remove volatile compounds. By volatile compounds, Applicants' mean materials having a boiling point less than about 100° C. at a pressure of about 100 mm Hg. In certain embodiments, in step 440 the appropriately dimensioned thermally conductive member is placed in a vacuum oven apparatus operated at a temperature of about 100° C., at a pressure of about 50 mm or less, for a period of about 24 hours. In certain embodiments, the appropriately dimensioned thermally conductive member is first solvent extracted in step 430 and then heated in a vacuum oven in step 440.

Regardless of the step(s) used to remove low molecular weight components, the treated thermally conductive elastomeric material has a Shore A hardness of between about 5 A and about 95 A, and a thermal conductivity λ of at least 1 after steps 420/430/440.

In step 450, the thermally conductive member is disposed within an electrically-insulating encapsulating film, such as encapsulating film 120. In certain embodiments, the film of step 450 comprises a dielectric strength of at least 15 kV/mm, an elongation at break of at least 100 percent, and a thermal conductivity of less than 0.5 W/mK.

In certain embodiments, step 450 further comprises forming a flexible enclosure comprising the film, inserting the member into that flexible enclosure, and sealing the flexible enclosure to form Applicants' electrically-insulating, gap-filling assembly.

In one embodiment, thermally conductive member 110 was placed between a first sheet of polymeric material, such as polyethylene, and a second sheet of polymeric material, such as polyethylene. The first sheet of polymeric material was then bonded to the second sheet of polyethylene along each of the plurality of edges 116 (FIG. 1) joining first side 112 (FIG. 1) and second side 114 (FIG. 1) of member 110 to form assembly 100 (FIG. 1).

In another embodiment, thermally conductive member 110 was placed between a first and a second sheet of a two layer polyethylene/polyethylene terephthalate laminate. In this embodiment, both first side 112 and second side 114 are disposed adjacent the polyethylene portion of that two layer laminate. The first sheet of laminate was then bonded to the second sheet of laminate along the edges of the thermally conductive member to form assembly 200.

In another embodiment, thermally conductive member 110 was placed between a first and a second sheet of a three layer metal/polyethylene/polyethylene terephthalate laminate. In this embodiment, both the upper and lower surfaces of member 100 contact the metal portion of the three layer laminate. The first sheet of laminate was then thermally bonded to the second sheet of laminate along the four edges of the thermally conductive member to form assembly 300.

While the preferred embodiments of the present invention have been illustrated in detail, it should be apparent that modifications and adaptations to those embodiments may occur to one skilled in the art without departing from the scope of the present invention as set forth in the following claims.

What is claimed is:

1. An electrically-insulating assembly, comprising:
a member having a thermal conductivity greater than 1 W/mK; and
a film encapsulating said member, wherein said film has a thermal conductivity of less than 0.5 W/mK, and wherein said encapsulating film prevents release from said electrically-insulating assembly of any silicone oils emitted by said member.

2. The thermally conductive assembly of claim 1, wherein said member comprises a Share A hardness between about 5 A and about 95 A.

3. The thermally conductive assembly of claim 1, wherein said film comprises a dielectric strength of at least 15 kV/mm.

4. The thermally conductive assembly of claim 3, wherein said film comprises a dielectric strength of at least 25 kV/mm.

5. The thermally conductive assembly of claim 3, wherein said film comprises an elongation at break of at least 100 percent.

6. The thermally conductive assembly of claim 3, wherein said film comprises an elongation at break of at least 300 percent.

7. The thermally conductive assembly of claim 1, wherein said film comprises polyethylene.

8. The thermally conductive assembly of claim 1, wherein said film comprises polyethylene terephthalate.

9. The thermally conductive assembly of claim 1, wherein said film comprises a two layer laminate.

10. The thermally conductive assembly of claim 9, wherein said laminate comprises a polyethylene layer and a polyethylene terephthate layer.

11. The thermally conductive assembly of claim 1, wherein said film comprises a three layer laminate.

12. The thermally conductive assembly of claim 11, wherein said three layer laminate comprises a metal layer, a polyethylene layer, and a polyethylene terephthate layer.

13. The thermally conductive assembly of claim 10, wherein said metal layer comprises aluminum.

14. A method to form an electrically-insulating assembly, comprising the steps of:
providing a member a member having a thermal conductivity greater than 1 W/mK;
providing a film having a thermal conductivity of less than 0.5 W/mK;
heating said member at a pressure less than atmospheric pressure;
encapsulating said elastomeric member with said film to form said electrically-insulating assembly, wherein said encapsulating film prevents release from said electrically-insulating assembly of any silicone oils emitted by said member.

15. The method of claim 14, wherein said providing a film step comprises providing a polyethylene film.

16. The method of claim 14, wherein said providing a film step comprises providing a polyethylene terephthalate film.

17. The method of claim 14, wherein said providing a film step comprises providing a two layer laminate comprising a layer of polyethylene film and a layer of polyethylene terephthalate film.

18. The method of claim 14, further comprising the step of extracting said member using a solvent.

19. The method of claim 14, wherein said encapsulating step further comprises the steps of:
forming a flexible enclosure comprising said film;
inserting said elastomeric member into said flexible enclosure; and
sealing said flexible enclosure.

20. The method of claim 14, wherein said encapsulating step further comprises the steps of:
providing a first sheet of polymeric material;
providing a second sheet of polymeric material;
disposing said elastomeric member between said first sheet of polymeric material and said second sheet of polymeric material; and
sealing said first sheet of polymeric material to said second sheet of polymeric material.
